(19) United States
(12) Patent Application Publication
(10) Pub. No.: US 2013/0276562 A1
(43) Pub. Date: Oct. 24, 2013

(54) HIGH LOAD CAPACITY SEAT ASSEMBLY AND DRIVE SYSTEM FOR SEAT ASSEMBLY

(71) Applicant: TICONA LLC, Florence, KY (US)

(72) Inventor: David Michael Sheridan, Royal Oak, MI (US)

(73) Assignee: Ticona LLC, Florence, KY (US)

(21) Appl. No.: 13/864,546

(22) Filed: Apr. 17, 2013

Related U.S. Application Data
(60) Provisional application No. 61/625,817, filed on Apr. 18, 2012.

(51) Int. Cl. B60N 2/06

(52) U.S. Cl. CPC B60N 2/067
USPC 74/89.32

(57) ABSTRACT

A drive system for moving a support assembly is disclosed. The drive system includes a lead screw configured for connection to the support assembly and defining a longitudinal axis. The drive system further includes an epicyclic gear assembly. The epicyclic gear assembly includes a carrier and a plurality of rotatable gears. The epicyclic gear assembly is rotationally coupled to the lead screw. Operation of the epicyclic gear assembly causes translation of the support assembly along the longitudinal axis.

### CROSS REFERENCE TO RELATED APPLICATIONS

The present application claims filing benefit of U.S. Provisional Patent application 61/625,817 having a filing date of Apr. 18, 2012 and which is incorporated herein by reference in its entirety.

### BACKGROUND OF THE INVENTION

Many seat assemblies, such as vehicle seat assemblies, are adjustable in a variety of directions. For example, vehicle seat assemblies may translate in a generally horizontal front-to-back direction, may translate in a vertical direction, and/or may rotate about various axes to recline or otherwise adjust. Drive systems are thus included in the seat assemblies to facilitate these adjustments.

For example, to translate in a front-to-back direction, a seat assembly may include a frame having one or more movable tracks mounted in one or more fixed tracks. The movable tracks translate with respect to the fixed tracks. Further, one or more lead screws may be connected to the movable tracks. Rotation of the lead screws may drive the movable tracks, and thus the seat assembly.

Typically, worm gears are utilized to drive the lead screws. Rotation of components of the worm gears cause rotation of the lead screws. However, various issues have arisen related to the use of worm gears to drive vehicle seat assemblies. In particular, worm gears have relatively low load capacity, due to friction and high contact stresses during operation. Frequently, the loads exerted on seat assemblies by, for example, users sitting or lying on the seat assemblies exceed the low load capacities of the worm gears. This can lead to damage to or failure of the worm gears.

Attempts have been made to increase the load capacity of such worm gears by forming the worm gear components from exotic materials having higher load capacities. However, these materials are typically expensive, and this additional material expense is undesirably passed on to the consumer.

Accordingly, an improved seat assembly and drive system for a seat assembly are desired in the art. Particularly, seat assemblies and drive systems with high load capacities, and that utilize commonly available materials, would be advantageous.

### SUMMARY OF THE INVENTION

In accordance with one embodiment of the present invention, a drive system for moving a support assembly is disclosed. The drive system includes a lead screw configured for connection to the support assembly and defining a longitudinal axis. The drive system further includes an epicyclic gear assembly. The epicyclic gear assembly includes a carrier and a plurality of rotatable gears. The epicyclic gear assembly is rotationally coupled to the lead screw. Operation of the epicyclic gear assembly causes translation of the support assembly along the longitudinal axis.

In accordance with another embodiment of the present invention, a seat assembly is disclosed. The seat assembly includes a support assembly configured to support a user, and a drive system connected to the support assembly and configured to move the support assembly. The drive system includes a lead screw attached to the support surface and defining a longitudinal axis. The drive system further includes an epicyclic gear assembly. The epicyclic gear assembly includes a carrier and a plurality of rotatable gears. The epicyclic gear assembly is rotationally coupled to the lead screw. Operation of the epicyclic gear assembly causes translation of the support assembly along the longitudinal axis.

Other features and aspects of the present invention are set forth in greater detail below.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 provides a side view of a seat assembly according to one embodiment of the present disclosure;

FIG. 2 provides a perspective view of a seat assembly frame according to one embodiment of the present disclosure;

FIG. 3 provides a perspective view of a drive system for a seat assembly according to one embodiment of the present disclosure wherein a lead screw is fixed and an epicyclic gear assembly is translatable;

FIG. 4 provides a perspective view of a drive system for a seat assembly according to another embodiment of the present disclosure wherein a lead screw is rotatable and an epicyclic gear assembly is fixed;

FIG. 5 provides a cross-sectional view of a drive system for a seat assembly according to one embodiment of the present disclosure wherein a lead screw is translatable and an epicyclic gear assembly is fixed; and

FIG. 6 provides a cross-sectional view of a drive system for a seat assembly according to another embodiment of the present disclosure wherein a lead screw is rotatable and an epicyclic gear assembly is fixed.

Repeat use of reference characters in the present specification and drawings is intended to represent the same or analogous features or elements of the present invention.

### DETAILED DESCRIPTION OF REPRESENTATIVE EMBODIMENTS

It is to be understood by one of ordinary skill in the art that the present discussion is a description of exemplary embodiments only, and is not intended as limiting the broader aspects of the present invention.

Generally speaking, the present disclosure is directed to drive systems for seat assemblies. The drive systems include epicyclic gear assemblies coupled to lead screws. The epicyclic gear assemblies are rotationally coupled to the lead screws, and operation thereof moves the seat assemblies. Epicyclic gear assemblies advantageously allow for load sharing between the various gears thereof, and thus have higher power densities and higher load capacities than, for example, worm gears. Thus, the present inventors have discovered that epicyclic gear assemblies as disclosed herein are particularly suited to drive seat assemblies. Further, drive systems and seat assemblies including epicyclic gear assemblies may be formed from commonly available materials, and are thus inexpensive while providing advantageous loading qualities.

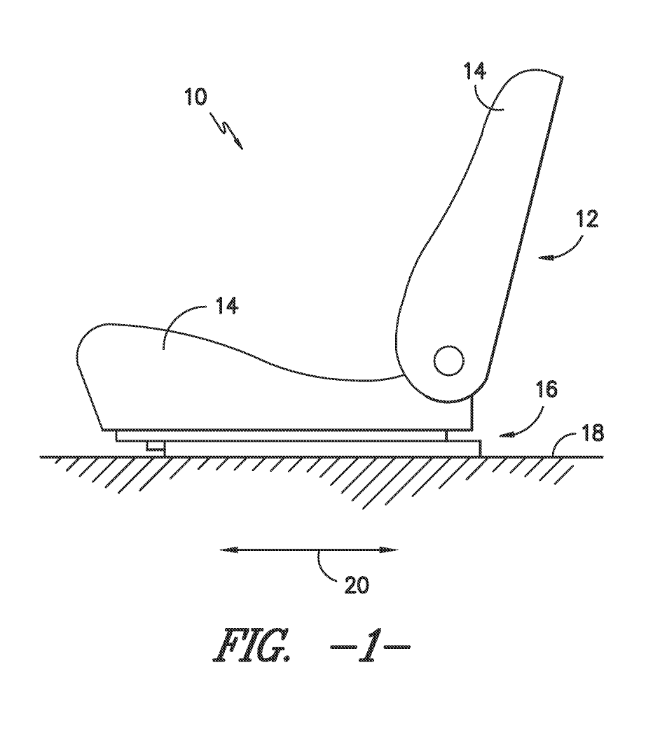

FIG. 1 provides a side view of a seat assembly 10 according to one embodiment of the present disclosure. In exemplary embodiments, the seat assembly 10 is a vehicle seat assembly 10, such as a front, middle, or rear seat of a vehicle. Alternatively, however, the seat assembly 10 may be utilized in any other suitable vehicle or non-vehicle related environment. A seat assembly 10 according to the present disclosure includes a support assembly 12. The support assembly 12 may include one or more support surfaces 14. Each support surface 14 may be configured to support a user thereon. For example, the support assembly 12 as shown in FIG. 1 includes a seat support surface 14 for a user to sit on, and a back support surface 14 for supporting the users back. The support surfaces 14 may be connected to each other, and may further be movable, such as rotatable or translatable, with respect to one another. Alternative support surfaces 14 may support users sitting or laying thereon in any suitable position or configuration. A support surface may be formed from any suitable materials, such as foam, cloth, rubber, etc., that can support a user.

As further illustrated in FIG. 1, a support assembly 12 may further include one or more frames 16. The frame 16 may be connected to one or more of the support surfaces 14, and may support the support surfaces 14 thereon. Further, a frame 16 may connect the support assembly 12 to a base 18, such as the floor of a vehicle, the ground, or a suitable base component.

A support assembly 12 according to the present disclosure may be movable in a variety of directions. In particular, a support assembly 12 may be translatable in a generally horizontal front-to-back direction 20, a generally horizontal side-to-side direction, or a vertical direction. For example, a frame 16 according to the present disclosure may include movable components that may cause movement of the support assembly 12.

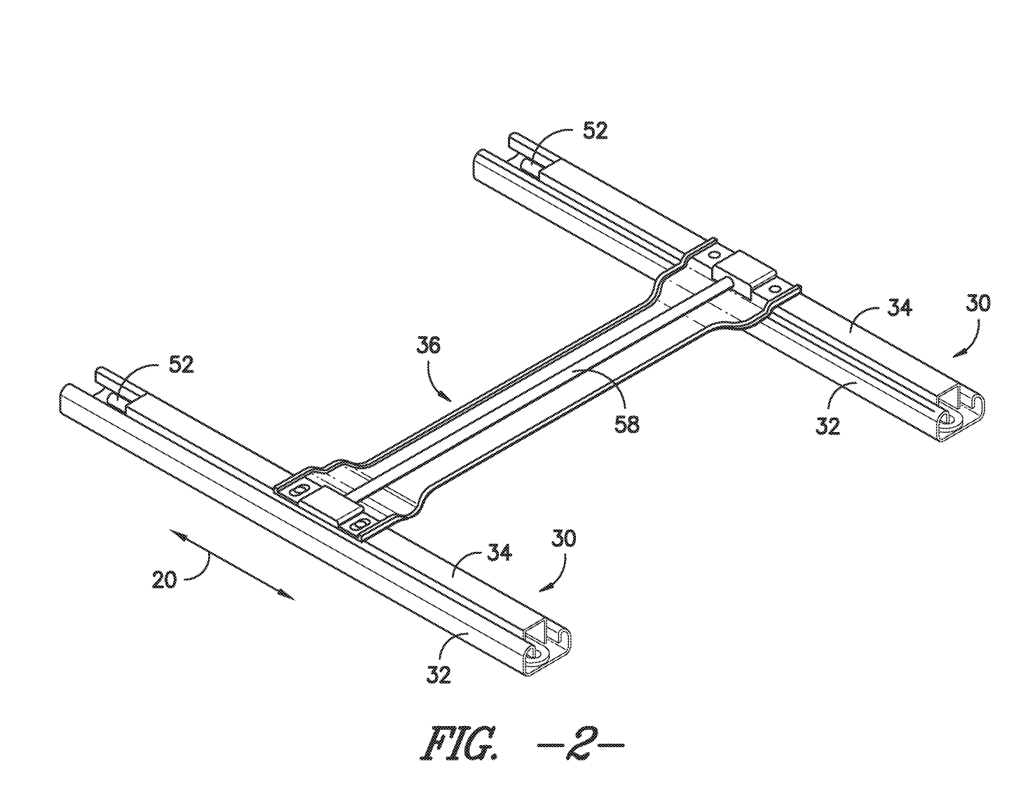

One embodiment of the various movable component of a frame 16 is shown in FIGS. 1 through 4. As shown, a frame 16 may include one or more tracks 30. Each track includes a fixed portion 32 and a movable portion 34. The fixed portions 32 may be connected to the base 18, and may have a generally fixed position. The movable portions 34 are movably coupled to the fixed portions 32, and may thus move with respect to the fixed portions 32. For example, as shown, a movable portion 34 may fit within or around a fixed portion 32, and may translate by sliding along the fixed portion 32. A movable portion 34 may further be connected to a support surface 14, such that movement of the movable portion 34 with respect to the fixed portion 32 moves the support assembly 12.

In some embodiments, a frame 16 according to the present disclosure may further include one or more cross-beams 36. The cross-beams 36 may extend generally transversely to the tracks 30, and may, for example, extend between two spaced apart generally parallel tracks 30 as shown. A cross-beam 36 may be connected to the fixed portion 32 or to the movable portion 34 of a track 30, and thus itself be fixed or movable. A cross-beam 36 may be connected to a support surface 14 in addition to or alternatively to movable portions 34 as discussed above.

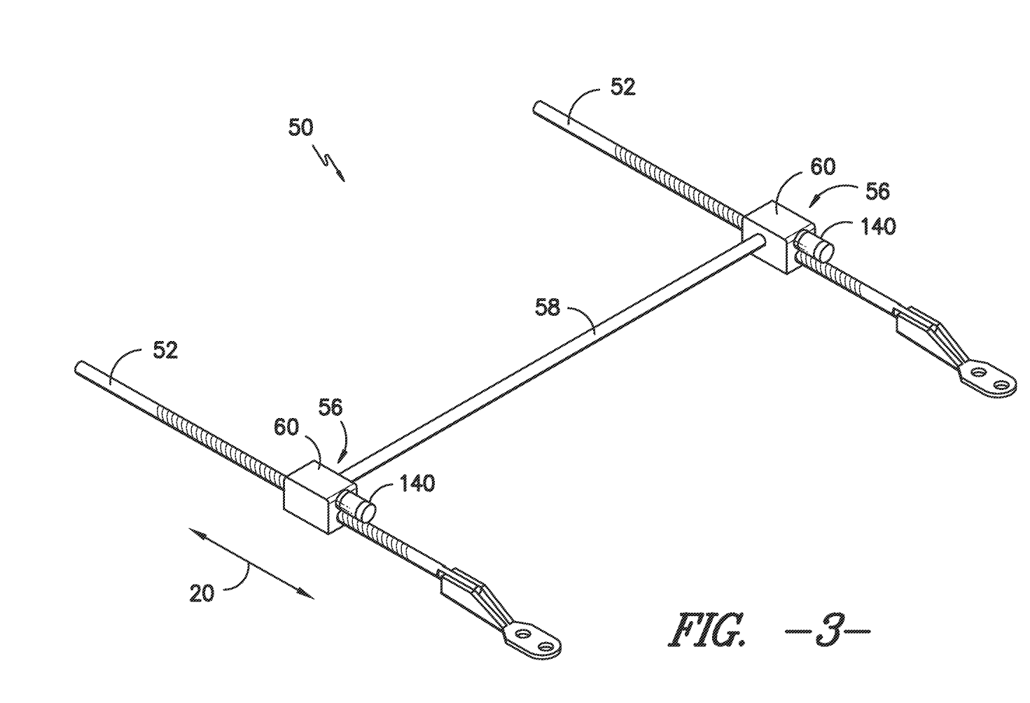

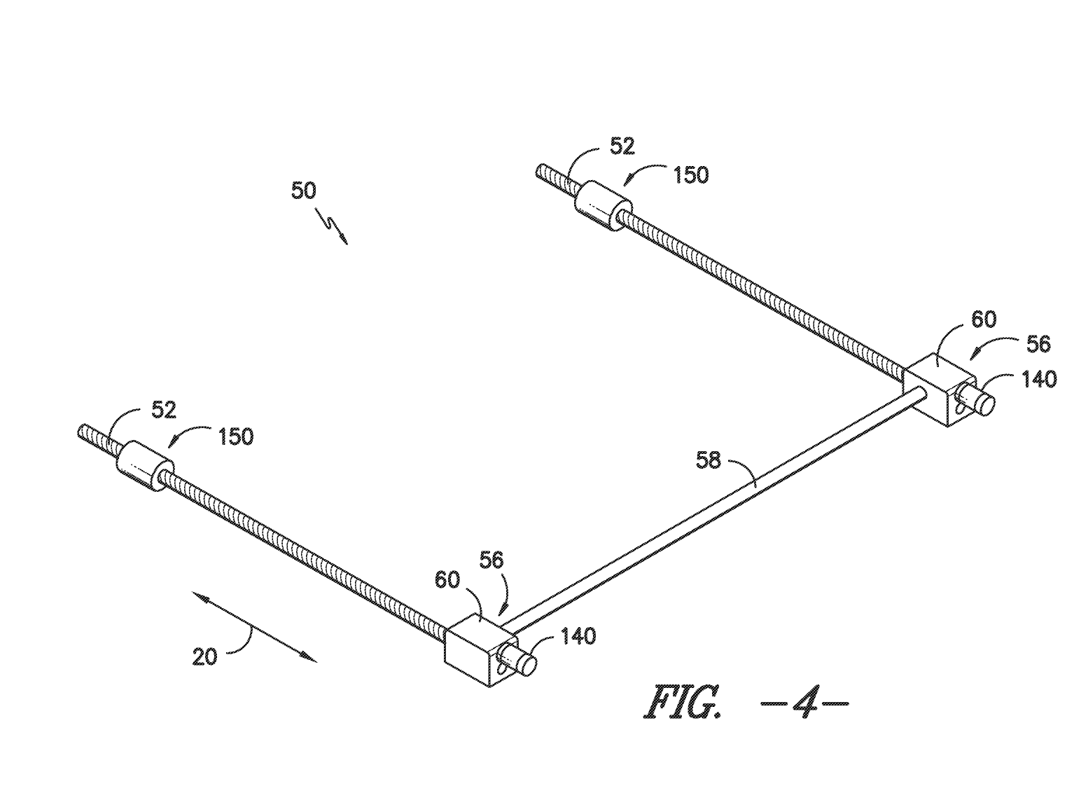

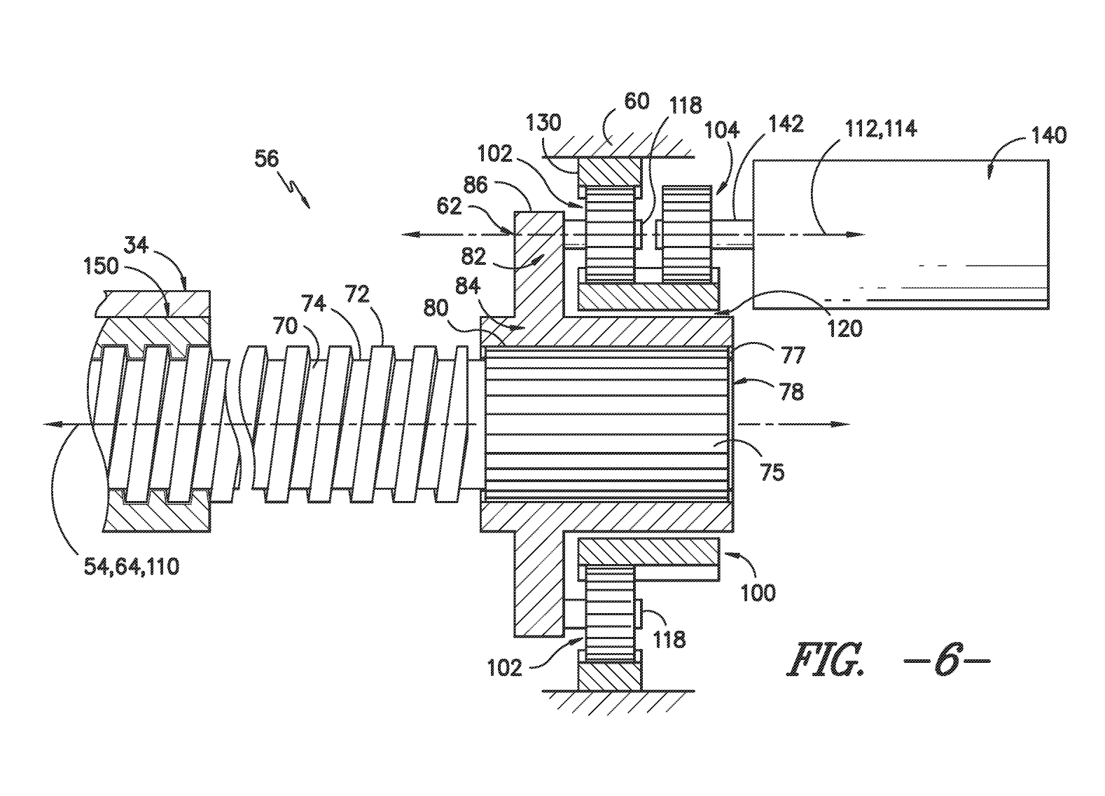

A seat assembly 10 according to the present disclosure may further include one or more drive systems 50, as shown in FIGS. 3 through 6. A drive system 50 may be connected to or configured for connection to a support assembly 12, and may further be configured to move the support assembly 12. For example, a drive system 50 may include one or more lead screws 52. A lead screw 52 may extend along a track 30, and may define a longitudinal axis 54 as shown. Further, a lead screw 52 may be housed within a track 30, such as between a movable portion 34 and a fixed portion 32 of a track 30. The lead screws 52 may further be fixed, as shown in FIG. 3, or movable, as shown in FIGS. 4 through 6. For example, in some embodiments, a lead screw 52 may be connected to a fixed portion 32 or directly to a base 18, such as through use of a bracket or other suitable connecting apparatus or through a direct connection. Alternatively, however, a lead screw 52 may be connected to a movable portion 34, such as through use of a bracket or other suitable connecting apparatus, or through a direct connection. In embodiments wherein the lead screw 52 rotates but does not translate, the lead screw 52 may, for example, be coupled to a movable portion 34 by a worm gear assembly, nut 150 as shown in FIGS. 4 and 6, or other suitable connecting apparatus that translates rotation of the lead screw 52 into translation of the movable portion 34. For example, as shown in FIG. 6, nut 150 may include threads configured to mesh with threads 72 of the lead screw 52, and which may for example be similar to threads 76 of carrier 62 as discussed below. In still other embodiments, a lead screw 52 may be freely rotational.

A drive system 50 according to the present disclosure may further include one or more epicyclic gear assemblies 56, as shown in FIGS. 3 through 5. An epicyclic gear assembly 56 generally includes one or more outer gears that mesh with, and may rotate about, one or more inner gears. An epicyclic gear assembly 56 may be housed within a track 30, such as between a movable portion 34 and a fixed portion 32 of a track 30. The epicyclic gear assembly 56 may further be fixed or movable. For example, in some embodiments, an epicyclic gear assembly 56 may be connected to a movable portion 34, such as through use of a bracket or other suitable connecting apparatus or through a direct connection. Alternatively, however, an epicyclic gear assembly 56 may be connected to a fixed portion 32 or directly to a base 18.

Any suitable epicyclic gear assembly 56 may be utilized in accordance with the present disclosure. For example, in exemplary embodiments, the epicyclic gear assembly 56 may be a planetary gear assembly. Alternatively, however, the epicylic gear assembly may be a star gear assembly, a solar gear assembly, or any other suitable epicyclic gear assembly. Still further, it should be understood that while the present disclosure describes various embodiments of single stage epicyclic gear assemblies, multiple stage epicyclic gear assemblies, epicyclic gear assemblies with differentials, and any other suitable varieties of epicyclic gear assemblies are within the scope and spirit of the present disclosure.

As shown in FIGS. 3 through 6 and discussed below, each epicyclic gear assembly 56 is rotationally coupled to a lead screw 52. Operation of the epicyclic gear assembly 56, and the various components thereof, may cause translation of the support assembly 12. For example, operation of the epicyclic gear assembly 56 may cause rotation of the lead screw 52 and/or rotation of an output component of the epicylic gear assembly 56, such as a carrier 62 or, alternatively, ring gear 130 or other suitable output. In some embodiments, such rotation may in turn cause translation of the epicyclic gear assembly 56 with respect to the lead screw 52 or translation of the lead screw 52 with respect to the epicyclic gear assembly 56. In other embodiments, such rotation may cause translation of a separate component coupling the lead screw 53 to a movable portion 34, such as a nut 150. Due to connection of the drive system 50 to the support assembly 12, such translation in turn will cause the support assembly 12 to translate. Such translation may occur in a generally horizontal front-to-back direction, a generally horizontal side-to-side direction, or a generally vertical direction or any other suitable direction having horizontal and/or vertical directional components.

In some embodiments, as shown, a rod 58 may couple various epicyclic gear assemblies 56 together. The rod 58 may maintain alignment of the epicyclic gear assemblies 56 with respect to each other during operation.

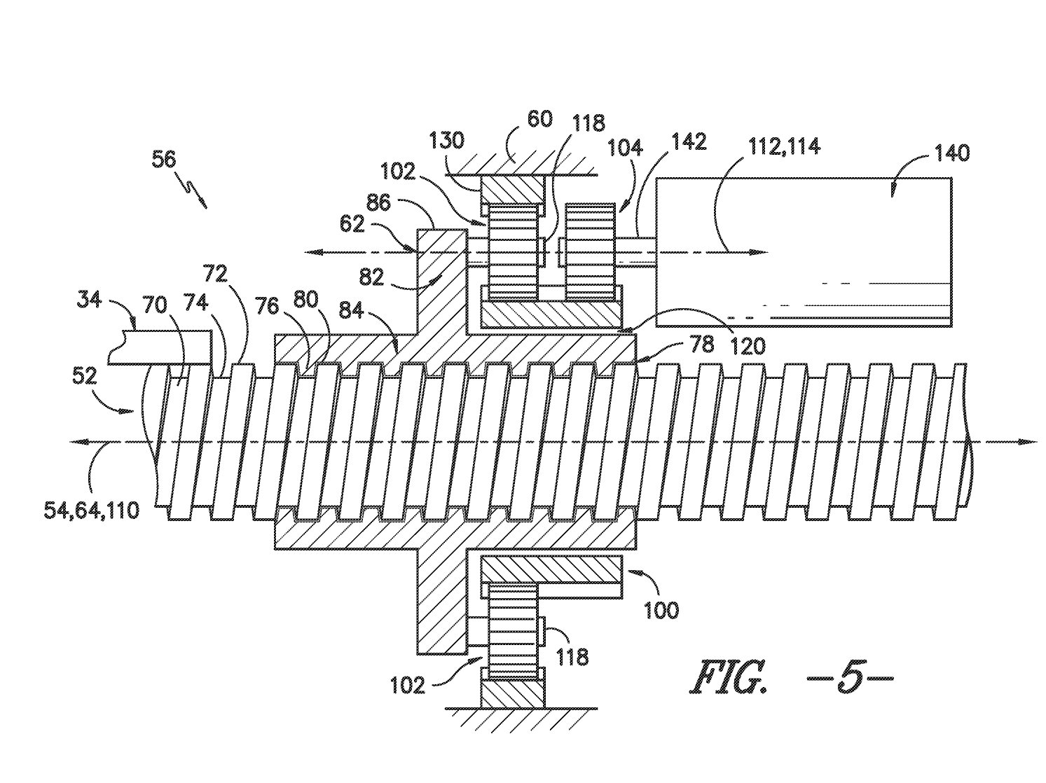

An epicyclic gear assembly 56 according to the present disclosure may include a gearbox 60, as shown in FIGS. 3 through 6. The gearbox 60 houses various components of the epicyclic gear assembly 56. An epicyclic gear assembly 56 further includes a carrier 62 and a plurality of rotatable gears. The carrier 62 may be rotatable about a central carrier axis 64, or stationary. As discussed, the epicyclic gear assembly 56 is coupled to the lead screw 52. For example, in some embodiments, the carrier 62 may be coupled to the lead screw 52. The carrier 62 in these embodiments may be rotatable about the central carrier axis 64. Rotation of the carrier 62 may cause translation of the lead screw 52 (FIG. 5), translation of the carrier 62 (FIG. 3), or translation of a nut 150 or other suitable component coupled to the lead screw 52 (FIGS. 4 and 6).

In exemplary embodiments, as shown in FIGS. 5 and 6 for example, the lead screw 52 includes a shaft 70 and one or more threads 72 defined on an outer surface 74 of the shaft 70. The threads 72 may be defined generally helically on the outer surface 74 of the shaft 70, to facilitate the conversion of rotational movement to translational movement as discussed. Further, the threads 72 may be straight or tapered, and may otherwise have any suitable size, shape, and orientation. The shaft 70 may have a constant diameter throughout the length of the lead screw 52, or the diameter may vary. For example, in some embodiments, the portion of the shaft 70 wherein the threads 72 are defined may have a larger diameter than other portions of the shaft 70, or may be smaller or have a generally similar diameter.

In some embodiments as shown in FIG. 6, the lead screw 52 includes one or more splines 75 defined on the outer surface 74. The splines 75 may be in addition to or alternative to the threads 72. The splines 75 may be defined on the outer surface 74 to facilitate rotational movement of the lead screw 62, generally without translational movement. The splines 75 may otherwise be straight or tapered, and may otherwise have any suitable size, shape, and orientation. Additionally or alternatively, the lead screw 52 may include one or more knurls or other suitable surface features, which may for example take the place of the splines 75.

The carrier 62 may include a plurality of threads 76, as shown in FIG. 5, or splines 77 (or knurls or other suitable surface features), as shown in FIG. 6. The threads 76 may be configured to mesh with the threads 72 of the lead screw 52, such that rotation of the carrier 62 drives translation of the lead screw 52. Thus, the threads 76 may, for example, have a helical orientation. The splines 77, on the other hand, may be configured to mesh with the splines 75 of the lead screw 52, such that rotation of the carrier 62 drives rotation of the lead screw 52. Further, in exemplary embodiments, as shown, the carrier 62 may define a central opening 78 therethrough. The central opening 78 may extend through the carrier 62 along the central carrier axis 64. As shown, the threads 76 or splines 77 may be defined on an inner surface 80 of the carrier 62. The lead screw 52 may extend through the central opening 78, and the threads 72 or splines 75 may thus mesh with the threads 76 or splines 77. In these embodiments, the central carrier axis 64 may be collinear with the longitudinal axis 54. Thus, during operation, as the carrier 62 rotates, the lead screw 52 may translate due to meshing of the threads 76 and threads 72 or rotate due to meshing of the splines 75 and splines 77.

Further, a carrier 62 according to the present disclosure may include, for example, an outer portion 82 and an inner nut portion 84, as shown in FIGS. 5 and 6. The outer nut portion 82 may define an outer surface 86 of the carrier 62, while the inner nut portion 84 may define the inner surface 80 of the carrier 62. The inner nut portion 84 may have a generally elongated body relative to the outer portion 82, to facilitate increased engagement and load distribution between the threads 76 and threads 72 or splines 77 and splines 75. Elongation of the body of the inner nut portion 84 may thus be generally along the central carrier axis 64.

It should be understood that the present disclosure is not limited to embodiments wherein the lead screw 52 extends through the carrier 62. For example, in other embodiments, the threads 76 or splines 77 may be defined on an outer surface 86 of the carrier 62, and the lead screw 52 and carrier 62 may be arranged such that the threads 72 and threads 76 or splines 75 and splines 77 thus mesh. In some of these embodiments, the carrier may include the nut portion as an outer portion relative to an inner portion, such that the nut portion defines the outer surface 86. Still further, the present disclosure is not limited to embodiments wherein the carrier 62 is coupled to the lead screw 52. For example, in other embodiments, any other suitable gear or component of the epicyclic gear assembly 56 may be coupled to the lead screw 52.

As discussed, the epicyclic gear assembly 56 may further include a plurality of rotatable gears. For example, the epicyclic gear assembly 56 may include a sun gear 100 and one or more planet gears 102, as well as a drive gear 104. Each of these gears may rotate about an individual axis. For example, the sun gear 100 may rotate about a central sun axis 110, each planet gear 102 may rotate about a central planet axis 112, and the drive gear may rotate about a central drive axis 114. Further, various of the rotatable gears may rotate about the axes of other gears. For example, as shown in FIG. 5, each planet gear 102 may additionally rotate about the central sun axis 110.

Each gear of an epicyclic gear assembly 56 according to the present disclosure may include a plurality of teeth defined on an outer surface thereof. The teeth may be sized and shaped to mesh together such that rotation of various of the gears may drive or be driven by rotation of other various gears.

Any suitable number of planet gears 102 may be utilized in an epicyclic gear assembly 56 of the present disclosure. For example, in some embodiments, between three and nine planet gears 102 may be utilized. In other embodiments, however, less than three or more than nine planet gears 102 may be utilized. Notably, the load capacity of a drive system 50 can be scaled through the use of different numbers of planet gears 102. Further, size of the drive system 50 can be scaled through the use of different numbers of planet gears 102. Thus, in various embodiments, various different numbers of planet gears may be utilized for various applications. The drive gear 104 may be separate from the planet gears 102, as shown, or alternatively the drive gear 104 may be one of the planet gears 102.

As shown in FIGS. 5 and 6, one or more of the planet gears 102 may be coupled to the carrier 62, and may thus drive rotation of the carrier 62. As discussed, a planet gear 102 may rotate about its central planet axis 112 as well as about the sun gear 100 and respective central sun axis 110. In other words, the planet gear 102 may rotate about its central planet axis 112, and the central planet axis 112 may rotate about the sun gear 100 and respective central sun axis 110. A pin 118 may extend through a central opening in a planet gear 102, such as along the central planet axis 112, to support the planet gear 102 thereon. This pin 118 may further be coupled to the carrier 62. For example, a mechanical fastener, such as a nut-bolt combination, a rivet, a screw, a nail, or other suitable mechanical fastener may couple the pin 118 to the carrier 62, or the pin 118 may extend through an opening in the carrier 62, or the pin 118 may be integral with the carrier 62. Rotation of the planet gears 102 about the central sun axis 110 may cause the pins 118 to similarly rotate. Rotation of the pins 118 may drive rotation of the carrier 62.

The sun gear 100 may in exemplary embodiments further define a central opening 120. The central opening 120 may extend through the sun gear 100 along the central sun axis 110. Further, the central sun axis 110 may be collinear with the longitudinal axis 54. The lead screw 52 may thus extend through the sun gear 100. Further, the central sun axis 110 and the central carrier axis 64 may be collinear. Thus, in some embodiments, a portion of the carrier 62, such as the inner nut portion 82, may extend at least partially through the central opening 120. It should be noted that the lead screw 52 and carrier 62 will typically not engage the sun gear 100, but merely include portions contained within the central opening 120. Thus, the lead screw 52 and carrier 62 may rotate within the central opening 120 without directly engaging the sun gear 100. In some embodiments, a bearing assembly may be included in the central opening 120 between the carrier 62, such as the inner nut portion 82 thereof, and the sun gear 100. This bearing assembly may facilitate relative rotation without direct engagement. In other embodiments, it should be understood that the inner nut portion 82 need not extend through the central opening 120.

An epicyclic gear assembly 56 according to the present disclosure may further include a ring gear 130. The ring gear 130 may at least partially surround other gears of the epicyclic gear assembly 56, such as the planet gears 102. Further, the ring gear 130 may be integral with or coupled to the gearbox 60. In exemplary embodiments as shown, the ring gear 130 may be fixed, such that no rotation occurs during operation of the epicyclic gear assembly 56. The planet gears 102 may thus rotate within the ring gear 130. Alternatively, however, the ring gear 130 may be rotatable, and may, for example, be the output gear coupled to the lead screw 52.

A motor 140 may be coupled to the drive gear 104 to drive the drive gear 104 and thus the epicyclic gear assembly 56. For example, as shown, a pin 142 may extend through a central opening in the drive gear 104, such as along the central drive axis 114, to support the drive gear 104 thereon. This pin 142 may further be coupled to the motor 140, and may typically be the shaft of the motor 140. For example, a mechanical fastener, such as a nut-bolt combination, a rivet, a screw, a nail, or other suitable mechanical fastener may couple the pin 142 to the motor 140, or the pin 142 may extend through an opening in the motor 140, or the pin 142 may be integral with the motor 140. Operation of the motor 140 may cause the pin 142 to rotate. Rotation of the pin 142 may drive rotation of the drive gear 104.

Any suitable materials may be utilized to form the various components of a drive system 50, such as the various gears and other components of the epicyclic gear assembly 56, according to the present disclosure. In exemplary embodiments, any of a variety of polymers, such as in exemplary embodiments thermoplastics, may be utilized.

In particular, materials suitable for forming components according to the present disclosure are commercially available and referred to as self-lubricating materials, such as polyoxymethylene (Acetal or POM) or polyetheretherketone (PEEK). These self-lubricating materials permit quiet long-term operation.

Suitable acetal resins generally are copolymers or homopolymers containing at least 90 mole %, preferably at least 95% mole % of oxymethylene units in the main chain. Preferredly, the acetal resins generally have a melt flow rate (MFR) (according to ASTM D-1238-79) at 190 C and under a load of 2.16 kg, of 0.1 to 50 g/10 min., preferably 0.2 to 30 g/10 min., more preferably 1.0 to 20 g/10 min, and most preferably from 5 to 15 g/10 min.

The preferred polyoxymethylene molding compositions comprise from 0.1 to 50.0% by weight of a tribological modifier, from 0.01-0.5% by weight of one or more stabilizers which contain at least one ring nitrogen atom, and from 0.05 to 1% by weight of a lubricant, for example an ester of a polyhydric alcohol and a fatty acid. The molding composition or the molding can moreover comprise other components, e.g. up to 0.5% by weight, preferably up to 0.2% by weight, of a metal salt fatty acid, b.9) carboxylic acid, up to 1.0% by weight of an antioxidant; and for UV protection, a sterically hindered phenol compound, up to 1.0% by weight of at least one other stabilizer, preferably from the group of the benzotriazole derivatives or benzophenone derivatives or aromatic benzoate derivatives. The preferred polyacetal materials are available under the CELCON or HOSTAFORM brands from Ticona worldwide.

It should be understood that the present disclosure is not limited to components formed from the above disclosed materials, and rather that any suitable materials, such as metals or metal alloys or otherwise, are within the scope and spirit of the present disclosure.

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A drive system for moving a support assembly, the drive system comprising:
a lead screw configured for connection to the support assembly and defining a longitudinal axis; and
an epicyclic gear assembly comprising a carrier and a plurality of rotatable gears, the epicyclic gear assembly rotationally coupled to the lead screw,
wherein operation of the epicyclic gear assembly causes translation of the support assembly along the longitudinal axis.

2. The drive system of claim 1, wherein operation of the epicyclic gear assembly causes rotation of the lead screw about the longitudinal axis.

3. The drive system of claim 1, wherein operation of the epicyclic gear assembly causes translation of the lead screw along the longitudinal axis.

4. The drive system of claim 1, wherein operation of the epicyclic gear assembly causes translation of the carrier along a central carrier axis.

5. The drive system of claim 1, wherein the lead screw comprises a shaft and a thread defined on an outer surface of the shaft.

6. The drive system of claim 1, wherein the carrier is rotatable about a central carrier axis.

7. The drive system of claim 6, wherein the lead screw is coupled to the carrier such that rotation of the carrier rotates the lead screw.

8. The drive system of claim 6, wherein the central carrier axis and the longitudinal axis are collinear.

9. The drive system of claim 1, wherein the lead screw extends through a central opening defined in the carrier.

10. The drive system of claim 1, wherein the carrier comprises an outer body portion and an inner nut portion.

11. The drive system of claim 1, wherein the plurality of rotatable gears comprises a plurality of planet gears, a sun gear, and a drive gear.

12. The drive system of claim 11, wherein a central sun axis of the sun gear and the longitudinal axis are collinear.

13. The drive system of claim 11, wherein the drive gear is coupled to the sun gear.

14. The drive system of claim 1, further comprising a motor configured to drive the epicyclic gear assembly.

15. A seat assembly, comprising:
a support assembly configured to support a user; and
a drive system connected to the support assembly and configured to move the support assembly, the drive system comprising:
a lead screw attached to the support surface and defining a longitudinal axis; and
an epicyclic gear assembly comprising a carrier and a plurality of rotatable gears, the epicyclic gear assembly rotationally coupled to the lead screw,
wherein operation of the epicyclic gear assembly causes translation of the support assembly along the longitudinal axis.

16. The seat assembly of claim 15, wherein operation of the epicyclic gear assembly causes rotation of the lead screw about the longitudinal axis.

17. The seat assembly of claim 15, wherein operation of the epicyclic gear assembly causes translation of the lead screw along the longitudinal axis.

18. The seat assembly of claim 15, wherein operation of the epicyclic gear assembly causes translation of the carrier along a central carrier axis.

19. The seat assembly of claim 15, wherein the lead screw comprises a shaft and a thread defined on an outer surface of the shaft.

20. The seat assembly of claim 15, wherein the carrier is rotatable about a central carrier axis.
